(19) United States
(12) Patent Application Publication
(10) Pub. No.: US 2026/0275005 A1
(43) Pub. Date: Sep. 17, 2026

(54) FLASH SPINNING POLYETHYLENE FILM MATERIAL WITH BETTER TOUGHNESS AND MANUFACTURING METHOD THEREOF

(71) Applicant: Kingwills Advanced Materials Co. Ltd., Nantong, Jiangsu Province (CN)

(72) Inventors: Kongmeng Ye, Nantong, Jiangsu Province (CN); Boyi CHEN, Nantong, Jiangsu Province (CN)

(21) Appl. No.: 18/873,114

(22) PCT Filed: Oct. 17, 2023
(86) PCT No.: PCT/CN2023/124906

§ 371 Date: Dec. 9, 2024

(30) Foreign Application Priority Data
Jul. 11, 2023 (CN) 202310841689.X

(51) Int. Cl. C08F 10/02; C08J 5/18

(52) U.S. Cl. CPC C08F 10/02; C08J 5/18

(57) ABSTRACT

A flash spinning polyethylene film material and a manufacturing method is provided. T the raw material comprises polyethylene, and a grammage G of the film material is greater than 50 g/m²; an initial toughness Z0 of the film material is 20 (N·m)/g-35 (N·m)/g; Z0=[RM×EM+RT×ET]/G; wherein RM is a tensile strength in an MD; RT is a tensile strength in a TD; EM is a tensile elongation in the MD; ET is a tensile elongation in the TD; the film material is exposed to a dry and hot atmosphere of 90° C. for 6 hours, cooled at 25° C. and a relative humidity of 65% for 24 hours, then its light transmittance is measured to be 8%-13%. The light transmittance is tested according to GBT2410-2008. The light transmittance is a ratio of luminous flux passing through a sample to the luminous flux incident on the sample, expressed as a percentage.

### TECHNICAL FIELD

The present disclosure belongs to the field of flash evaporation technology, and in particular relates to a flash spinning polyethylene film material with better toughness and a manufacturing method thereof.

### BACKGROUND

The research on the mechanical property of a film material began in the 1980s, wherein countries such as Europe, the United States, and Japan, which are leading in the field of a film structure, have carried out a large amount of research work. The Rain Blom Laboratory in Germany is the largest film material mechanical property research laboratory in Europe, and has established a unified test method for a film material in terms of strength indicators such as tensile strength, tear strength, and peel strength, as well as determining engineering constants such as elastic modulus, Poisson's ratio, and shear modulus through a biaxial tensile test. This method has been adopted by industry organizations such as Tensinet. Japan also established unified test standards for a film material property in 1993, 1995, and 2003; the test scope includes tests of strength indicators, engineering constants, as well as performance tests under long-term working conditions such as creepage, stress relaxation, bending resistance, high and low temperature, waterproofing, and weather resistance.

In 1997, a stadium with a capacity of 80000 people in Shanghai adopted a film structure (skeleton film structure), which has a development history of nearly ten years in China. Significant progress has been made in a film structure design calculation and an engineering application. In terms of a design calculation, numerous universities and other research institutions have conducted in-depth theoretical research on the form-finding analysis, force analysis, cutting analysis, and other aspects of a film structure. They have developed a large number of related software for engineering practice and compiled a film structure regulation based on domestic and foreign application experience to guide film structure design and construction. In terms of an engineering application, from an early small-scale film structure to a large-scale film structure such as a sports stadium and an exhibition hall, a structural form has also included a tensioned film structure, a skeleton film structure, and an inflatable film structure; and in terms of a film material application, a PVC film materials, a PTFE film material, and the latest PE film material have all been used, wherein the PVC film material is widely used in early and small-scale film structures, the PTFE film material is mainly used in large-scale iconic film structures, and an ETFE film material has been applied in China since the Beijing Olympic Swimming Center.

The PVC film material is inexpensive and comes in various colors including white, red, blue, and green, making it widely used. The film material is soft and has good tensile properties, making it easy to produce and stretch, and has good adaptability to cutting errors. However, its durability and self-cleaning property are poor. As the material ages, its performance changes due to the outward movement of a coating enhancer and the action of ultraviolet radiation. The surface gradually turns yellow and sticky, and dust and dirt in the air adhere to the film surface, causing the surface to become dirty and the light transmittance to decrease, thereby reducing its service life. To improve the durability and the self-cleaning property of such membrane materials, a polyvinyl fluoride (PVF) surface layer or a polyvinylidene fluoride (PVDF) surface layer can be added outside the coating.

The PTFE film material has good durability and will not yellow or mold in atmospheric environments; moreover, a PTFE building film material has good self-cleaning property, and rainwater will form droplets on its surface and flow away. But its price is relatively expensive. Moreover, a stiffness of the film material is high, and rolling and folding during transportation and construction will reduce the strength of the film material. Therefore, the construction convenience is poor, and a precise calculation needs to be carried out in a design process and a cutting process.

The PE film material is formed by biaxial stretching and can be divided into a wet method or a dry method. For the PE film material formed by flash evaporation method, DuPont was the first to discover it in 1960 and then promoted its application. DuPont has been monopolizing this technology until now. Our company started the research and development of flash evaporation method in 2014, established a pilot production line in 2020, and achieved large-scale production in 2022. Through research, it has been found that an existing flash evaporation film material has technical problems such as insufficient toughness and poor transparency. The present application overcomes existing technical bottlenecks and expands its application scope by adding functional particles and improving a spinning process.

US Patent Publication No. US20200274122A1 relates to a separator medium for an electrochemical cell, which comprises at least one non-woven polymer fiber sheet. The non-woven sheet has a surface area of about 0.5 m²/g to about 1.5 m²/g, with a maximum pore size equal to or greater than 2.5 times the average flow pore size and greater than 11 times the minimum pore size. The sheet can be sulfonated to a level of 0.67% and exhibits an excellent tensile property after sulfonation compared to a previously known separator.

US Patent US20190160782A1 relates to a non-fiber oriented polyethylene monolayer comprising ultra-high molecular weight polyethylene, wherein the polyethylene has a viscosity average molecular weight of 2000000 or greater, wherein (I) the monolayer has a width of 10.0 mm or greater and a modulus/tex of at least 100 N, (ii) when measured in a dynamic mechanical analysis (DMA) of a tensile response in a frequency scan between 0.1 Hz<f<1.0 Hz, the monolayer has tanδ, satisfying the inequality tanδ<1/(f×a), and (iii) the monolayer has a maximum area weight not greater than 45 gsm.

European patent EP3736126A1 relates to a package for providing a disinfectable enclosed internal environment, and a breathable fiber non-woven sheet structure for such a structure, wherein the non-woven sheet structure has at least one surface with a pre-sealed embossed pattern; and a particle barrier penetration rate is less than 10%, a Gurley Hill porosity is 40 seconds or less, and a moisture transmission rate is 3500 g/m²/day or higher.

U.S. Patent U.S. Pat. No. 8,048,513, the present disclosure relates to an improved plexifilamentary sheet for use in a protective clothing and a filter media, wherein the material is composed of substantially continuous polyethylene plexifilamentary fiber bundles and has a Frazier permeability, normalized to 1.0 oz/yd², of at least 2 cfm/ft².

However, there is no relevant research in the prior art on how to adjust and change the toughness and the light transmittance of the flash evaporation film material.

### SUMMARY OF THE INVENTION

The purpose of the present disclosure is to provide a flash spinning polyethylene film material with better toughness to solve the above-mentioned problems.

Another purpose of the present disclosure is to provide a manufacturing method of a flash spinning polyethylene film material with better toughness.

In order to achieve the above-mentioned purposes, the present disclosure adopts the following technical solutions:
a flash spinning polyethylene film material with better toughness, wherein a raw material thereof comprises polyethylene,
a grammage G of the flash spinning polyethylene film material is greater than 50 g/m²;
an initial toughness Z₀ of the flash spinning polyethylene film material is 20 (N·m)/g-35 (N·m)/g;

$${Z}_{0} = [ {R}_{M} \times {E}_{M} + {R}_{T} \times {E}_{T} ] / G ;$$

wherein,
R_{M} is a tensile strength in an MD direction;
R_{T} is a tensile strength in a TD direction;
E_{M} is a tensile elongation in an MD direction;
E_{T} is a tensile elongation in a TD direction;
the flash spinning polyethylene film material is exposed to a dry and hot atmosphere of 90° C. for 6 hours, and then cooled at 25° C. and a relative humidity of 65% for 24 hours; then a light transmittance thereof is measured to be 8%-13%; and
the light transmittance is tested according to GBT2410-2008, and the light transmittance is a ratio of a luminous flux passing through a sample to a luminous flux incident on the sample, expressed as a percentage.

The initial toughness Z₀ of the flash spinning polyethylene film material is 20 (N·m)/g-25 (N·m)/g.

The initial toughness Z₀ of the flash spinning polyethylene film material is 25 (N·m)/g-30 (N·m)/g.

The initial toughness Z₀ of the flash spinning polyethylene film material is 30 (N·m)/g-35 (N·m)/g.

The light transmittance of the flash spinning polyethylene film material is 8%-9%.

The light transmittance of the flash spinning polyethylene film material is 9%-10%.

The light transmittance of the flash spinning polyethylene film material is 10%-11%.

A flash spinning polyethylene film material with better toughness, wherein a toughness change value •Z of the flash spinning polyethylene film material is 15%-25%;
wherein: •Z=[Z₀−Z₁₀]/Z₀*100%
Z₀ is the initial toughness, and the initial toughness is Z₀=[R_{M}×E_{M}+R_{T}×E_{T}]/G of the sample;
Z₁₀ is a final toughness Z₁₀ after high temperature treatment, and Z₁₀=[R_{M10}×E_{M10}+R_{T10}×E_{T10}]/G;
the process flow of the high temperature treatment is as follows:
(1) placing a sample at 25° C. and a relative humidity of 65% for 24 hours, and then measuring the tensile strength R_{M} in the MD direction, the tensile strength R_{T} in the TD direction, the tensile elongation E_{M} in the MD direction, and the tensile elongation E_{T} in the TD direction of the sample separately; then calculating Z₀ according to a formula;
(2) then exposing the sample to a dry and hot atmosphere of 90° C. for 6 hours, and then cooling at 25° C. and a relative humidity of 65% for 24 hours; and
(3) finally repeating the operation of step (2), and after treatment for 9 times, and finally measuring the tensile strength R_{M10} in the MD direction, the tensile strength R_{T10} in the TD direction, the tensile elongation E_{M10} in the MD direction, and the tensile elongation E_{T10} in the TD direction of the sample separately; then calculating Z₁₀ according to the formula.

The toughness change value •Z of the flash spinning polyethylene film material is 15%-20%.

The toughness change value •Z of the flash spinning polyethylene film material is 20%-25%.

The grammage G of the flash spinning polyethylene film material is greater than 60 g/m².

The grammage G of the flash spinning polyethylene film material is less than 120 g/m².

The grammage G of the flash spinning polyethylene film material is less than 100 g/m².

The grammage G of the flash spinning polyethylene film material is less than 80 g/m².

A manufacturing method of a flash spinning polyethylene film material with better toughness, wherein specific steps are as follows:
(1) manufacturing of a flash evaporation spinning solution:
adding a spinning raw material and a spinning solvent into a high-pressure reaction kettle, and then heating up to 160° C.-180° C.; introducing nitrogen gas at the end of the heating, and pressurizing to 12.5 MPa-13 MPa; and finally heating up to 200° C.-230° C. to obtain the flash evaporation spinning solution;
the spinning raw material comprises polyethylene and tough particles; and
a mass fraction of the tough particles in the spinning raw material is 1.5%-2.5%;
the tough particles are wrinkled graphene oxide microspheres; a specific surface area is 230 m²/g-250 m²/g, and a density is only 40 mg/cm³−50 mg/cm³; and the wrinkled graphene oxide microspheres utilize their unique wrinkled structure to play a role of buffering when a product is subjected to an external force, thereby enhancing its tensile strength.

The spinning solvent includes aromatic hydrocarbons, unsaturated hydrocarbons, halogenated hydrocarbons, alcohols, esters, ethers, ketones, fluorocarbons, etc. The spinning solvent is dichloromethane, 1,1-dichloro-2,2,2-trifluoroethane, monochlorodichloromethane, and 1H-perfluorohexane, with a mass ratio of 6:2:1:1.

A mass fraction of the spinning raw material in the flash evaporation spinning solution is 7%-17%.
(2) Manufacturing of the flash spinning polyethylene film material:
making the flash evaporation spinning solution manufactured in step (1) pass through a decompression chamber whose outlet being set a spinning component, performing flash spinning on the flash evaporation spinning solution through a spinning component to obtain flash spun fibers which enter a laying system through a spinning baffle to obtain a raw fabric; pre-pressing the raw fabric preliminarily by an upper pre-pressing roller and a lower pre-pressing roller, then making it enter a water tank, and controlling a sizing rate by a left extrusion roller and a right extrusion roller through a transmission rod to obtain a pulp-containing raw fabric; making the pulp-containing raw fabric pass through an upper preheat rolling rod, a lower preheat rolling rod, an upper heat rolling rod, a lower heat rolling rod, an upper pre-calendering rod, a lower pre-calendering rod, an upper calendering rod, a lower calendering rod in sequence, and finally pass through a winding machine to obtain the flash spinning polyethylene film material; and
the water tank has a deionized water solution comprising a surfactant. When the deionized water solution is a pure deionized water, there may be local penetration points during the subsequent hot pressing process, mainly due to the uneven dispersion of deionized water in a felt. The present application overcomes its dispersion problem by adding the surfactant, thereby reducing the generation of local bright spots. The purpose of increasing a water tank treatment process is to allow water vapor to penetrate the fiber during heat rolling of the pulp-containing raw fabric, thereby improving heat transfer efficiency, achieving uniform bonding and product distribution, and enhancing tensile strength.

A mass fraction of the surfactant in the deionized water solution is 15%-25%;
the surfactant is a diacetyl piperazine quaternary ammonium salt-Gemini surfactant;
the sizing rate is 8%-14%, wherein the calculation of the sizing rate is [(wet weight-dry weight)/dry weight]*100%
a temperature of the heat rolling of the upper preheat rolling rod and the lower preheat rolling rod is 104° C.-106° C.;
a temperature of the hot rolling of the upper heat rolling rod and the lower heat rolling rod is 109° C.-111° C.;
a temperature of the hot rolling of the upper pre-calendering rod and the lower pre-calendering rod is 114° C.-116° C.; and
a temperature of the hot rolling of the upper calendering rod and the lower calendering rod is 119° C.-121° C.

Compared with the prior art, the present invention has the following positive effects:
1. the present disclosure has found that adding a certain amount of tough particles to the spinning raw material can significantly affect the toughness of the final product, and also have a certain impact on the light transmittance.
2. The present disclosure mainly utilizes the high heat transfer efficiency of water vapor after treating the raw fabric with a deionized water solution of a surfactant. During hot rolling and calendering, water vapor easily passes through the fibers, achieving uniform bonding and product distribution, thereby affecting its toughness and transparency.

### BRIEF DESCRIPTION OF THE DRAWINGS

FIG. 1 is a schematic diagram of the structure of the present disclosure;

In the figure: a spinning component 1, a baffle 2, flash spun fibers 3, a laying system 4, a guide roller 5, a water tank 6, an upper pre-pressing roller 10, a lower pre-pressing roller 11, a transmission rod 12, a left extrusion roller 13, a right extrusion roller 14, an upper preheat rolling rod 15, a lower preheat rolling rod 16, an upper heat rolling rod 17, a lower heat rolling rod 18, an upper pre-calendering rod 19, a lower pre-calendering rod 20, an upper calendering rod 21, a lower calendering rod 22, and a winding machine 23.

### DETAILED DESCRIPTION OF THE INVENTION

The present disclosure will be described in further detail below in conjunction with the accompanying drawings of the specification and specific embodiments.

### Example 1

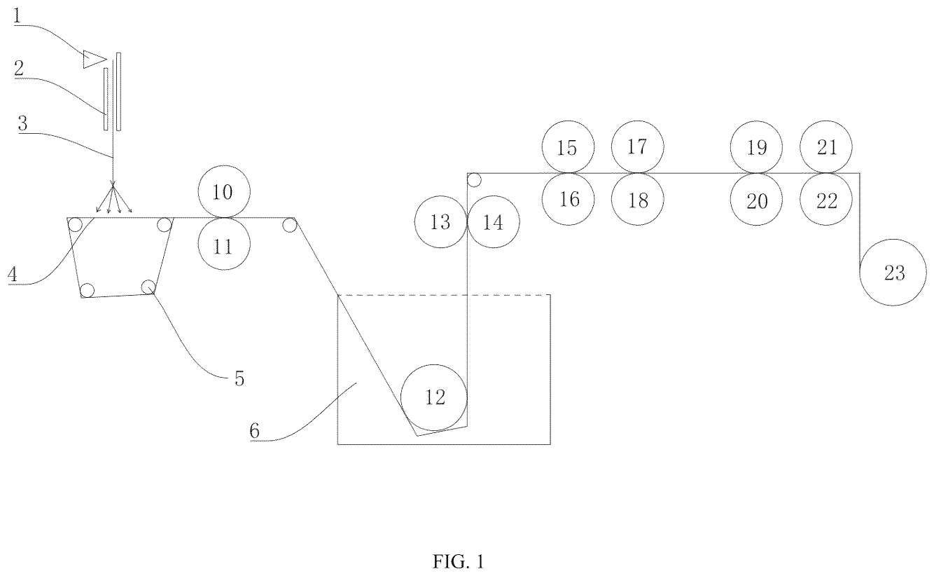

This embodiment provides a manufacturing method of a flash spinning polyethylene film material with better toughness. Referring to FIG. 1, the specific steps are as follows:
(1) manufacturing of a flash evaporation spinning solution:
adding a spinning raw material and a spinning solvent into a high-pressure reaction kettle, and then heating up to 160° C.; introducing nitrogen gas at the end of the heating, and pressurizing to 12.5 MPa; and finally heating up to 200° C. to obtain the flash evaporation spinning solution;
the spinning raw material comprises polyethylene and tough particles; and
a mass fraction of the tough particles in the spinning raw material is 1.5%;
the tough particles are wrinkled graphene oxide microspheres; a specific surface area is 230 m²/g-250 m²/g, and a density is only 40 mg/cm³−50 mg/cm³; and the wrinkled graphene oxide microspheres utilize their unique wrinkled structure to play a role of buffering when a product is subjected to an external force, thereby enhancing its tensile strength.

Among them, the wrinkled graphene oxide microspheres are prepared by the following method: adding a graphite powder to sulfuric acid and stirring evenly, then sequentially adding potassium ferrate and a hydrogen peroxide solution for intercalation oxidation, separating and washing with water, drying to obtain an oxidized graphene, rapidly heating the oxidized graphene in a nitrogen atmosphere, and performing high-temperature calcination to obtain the wrinkled graphene oxide microspheres.

The spinning solvent is dichloromethane, 1,1-dichloro-2,2,2-trifluoroethane, monochlorodichloromethane, and 1H-perfluorohexane, with a mass ratio of 6:2:1:1.

A mass fraction of the spinning raw material in the flash evaporation spinning solution is 8%.
(2) Manufacturing of the flash spinning polyethylene film material:
making the flash evaporation spinning solution manufactured in step (1) pass through a decompression chamber whose outlet being set a spinning component 1, performing flash spinning on the flash evaporation spinning solution through a spinning component to obtain flash spun fibers 3 which enter a laying system 4 through a spinning baffle 2 to obtain a raw fabric; pre-pressing the raw fabric preliminarily by an upper pre-pressing roller 10 and a lower pre-pressing roller 11, then making it enter a water tank 6, and controlling a sizing rate by a left extrusion roller 13 and a right extrusion roller 14 through a transmission rod 12 to obtain a pulp-containing raw fabric; making the pulp-containing raw fabric pass through an upper preheat rolling rod 15, a lower preheat rolling rod 16, an upper heat rolling rod 17, a lower heat rolling rod 18, an upper pre-calendering rod 19, a lower pre-calendering rod 20, an upper calendering rod 21, a lower calendering rod 22 in sequence, and finally pass through a winding machine 23 to obtain the flash spinning polyethylene film material; and
the water tank has a deionized water solution comprising a surfactant. When the deionized water solution is a pure deionized water, there may be local penetration points during the subsequent hot pressing process, mainly due to the uneven dispersion of deionized water in a felt. The present application overcomes its dispersion problem by adding the surfactant, thereby reducing the generation of local bright spots.

A mass fraction of the surfactant in the deionized water solution is 15%;
the surfactant is a diacetyl piperazine quaternary ammonium salt-Gemini surfactant;
the sizing rate is 9%, wherein the calculation of the sizing rate is [(wet weight-dry weight)/dry weight]*100%
a temperature of the heat rolling of the upper preheat rolling rod 15 and the lower preheat rolling rod 16 is 104° C.;
a temperature of the hot rolling of the upper heat rolling rod 17 and the lower heat rolling rod 18 is 109° C.;
a temperature of the hot rolling of the upper pre-calendering rod 19 and the lower pre-calendering rod 20 is 114° C.; and
a temperature of the hot rolling of the upper calendering rod 21 and the lower calendering rod 22 is 119° C.

The test results of this embodiment are shown in Table 1.

### Example 2

This embodiment provides a manufacturing method of a flash spinning polyethylene film material with better toughness. Referring to FIG. 1, the specific steps are as follows:
(1) manufacturing of a flash evaporation spinning solution:
adding a spinning raw material and a spinning solvent into a high-pressure reaction kettle, and then heating up to 170° C.; introducing nitrogen gas at the end of the heating, and pressurizing to 12.8 MPa; and finally heating up to 215° C. to obtain the flash evaporation spinning solution;
the spinning raw material comprises polyethylene and tough particles; and
a mass fraction of the tough particles in the spinning raw material is 2%;
the tough particles are wrinkled graphene oxide microspheres; a specific surface area is 230 m²/g-250 m²/g, and a density is only 40 mg/cm³−50 mg/cm³; and the wrinkled graphene oxide microspheres utilize their unique wrinkled structure to play a role of buffering when a product is subjected to an external force, thereby enhancing its tensile strength.

The manufacturing method of the wrinkled graphene oxide microspheres is the same as that in Example 1, so it will not be repeated here.

The spinning solvent is dichloromethane, 1,1-dichloro-2,2,2-trifluoroethane, monochlorodichloromethane, and 1H-perfluorohexane, with a mass ratio of 6:2:1:1.

A mass fraction of the spinning raw material in the flash evaporation spinning solution is 11%.
(2) Manufacturing of the flash spinning polyethylene film material:
making the flash evaporation spinning solution manufactured in step (1) pass through a decompression chamber whose outlet being set a spinning component 1, performing flash spinning on the flash evaporation spinning solution through a spinning component to obtain flash spun fibers 3 which enter a laying system 4 through a spinning baffle 2 to obtain a raw fabric; pre-pressing the raw fabric preliminarily by an upper pre-pressing roller 10 and a lower pre-pressing roller 11, then making it enter a water tank 6, and controlling a sizing rate by a left extrusion roller 13 and a right extrusion roller 14 through a transmission rod 12 to obtain a pulp-containing raw fabric; making the pulp-containing raw fabric pass through an upper preheat rolling rod 15, a lower preheat rolling rod 16, an upper heat rolling rod 17, a lower heat rolling rod 18, an upper pre-calendering rod 19, a lower pre-calendering rod 20, an upper calendering rod 21, a lower calendering rod 22 in sequence, and finally pass through a winding machine 23 to obtain the flash spinning polyethylene film material; and
the water tank has a deionized water solution comprising a surfactant. When the deionized water solution is a pure deionized water, there may be local penetration points during the subsequent hot pressing process, mainly due to the uneven dispersion of deionized water in a felt. The present application overcomes its dispersion problem by adding the surfactant, thereby reducing the generation of local bright spots.

A mass fraction of the surfactant in the deionized water solution is 20%;
the surfactant is a diacetyl piperazine quaternary ammonium salt-Gemini surfactant;
the sizing rate is 11%, wherein the calculation of the sizing rate is [(wet weight-dry weight)/dry weight]*100%
a temperature of the heat rolling of the upper preheat rolling rod 15 and the lower preheat rolling rod 16 is 105° C.;
a temperature of the hot rolling of the upper heat rolling rod 17 and the lower heat rolling rod 18 is 110° C.;
a temperature of the hot rolling of the upper pre-calendering rod 19 and the lower pre-calendering rod 20 is 115° C.; and
a temperature of the hot rolling of the upper calendering rod 21 and the lower calendering rod 22 is 120° C.

The test results of this embodiment are shown in Table 1.

### Example 3

This embodiment provides a manufacturing method of a flash spinning polyethylene film material with better toughness. Referring to FIG. 1, the specific steps are as follows:
(1) manufacturing of a flash evaporation spinning solution:
adding a spinning raw material and a spinning solvent into a high-pressure reaction kettle, and then heating up to 180° C.; introducing nitrogen gas at the end of the heating, and pressurizing to 13 MPa; and finally heating up to 230° C. to obtain the flash evaporation spinning solution;
the spinning raw material comprises polyethylene and tough particles; and
a mass fraction of the tough particles in the spinning raw material is 2.5%;
the tough particles are wrinkled graphene oxide microspheres; a specific surface area is 230 m²/g-250 m²/g, and a density is only 40 mg/cm³−50 mg/cm³; and the wrinkled graphene oxide microspheres utilize their unique wrinkled structure to play a role of buffering when a product is subjected to an external force, thereby enhancing its tensile strength.

The manufacturing method of the wrinkled graphene oxide microspheres is the same as that in Example 1, so it will not be repeated here.

The spinning solvent is dichloromethane, 1,1-dichloro-2,2,2-trifluoroethane, monochlorodichloromethane, and 1H-perfluorohexane, with a mass ratio of 6:2:1:1.

A mass fraction of the spinning raw material in the flash evaporation spinning solution is 15%.
(2) Manufacturing of the flash spinning polyethylene film material:
making the flash evaporation spinning solution manufactured in step (1) pass through a decompression chamber whose outlet being set a spinning component 1, performing flash spinning on the flash evaporation spinning solution through a spinning component to obtain flash spun fibers 3 which enter a laying system 4 through a spinning baffle 2 to obtain a raw fabric; pre-pressing the raw fabric preliminarily by an upper pre-pressing roller 10 and a lower pre-pressing roller 11, then making it enter a water tank 6, and controlling a sizing rate by a left extrusion roller 13 and a right extrusion roller 14 through a transmission rod 12 to obtain a pulp-containing raw fabric; making the pulp-containing raw fabric pass through an upper preheat rolling rod 15, a lower preheat rolling rod 16, an upper heat rolling rod 17, a lower heat rolling rod 18, an upper pre-calendering rod 19, a lower pre-calendering rod 20, an upper calendering rod 21, a lower calendering rod 22 in sequence, and finally pass through a winding machine 23 to obtain the flash spinning polyethylene film material; and
the water tank has a deionized water solution comprising a surfactant. When the deionized water solution is a pure deionized water, there may be local penetration points during the subsequent hot pressing process, mainly due to the uneven dispersion of deionized water in a felt. The present application overcomes its dispersion problem by adding the surfactant, thereby reducing the generation of local bright spots.

A mass fraction of the surfactant in the deionized water solution is 24%;
the surfactant is a diacetyl piperazine quaternary ammonium salt-Gemini surfactant;
the sizing rate is 13%, wherein the calculation of the sizing rate is [(wet weight-dry weight)/dry weight]*100%
a temperature of the heat rolling of the upper preheat rolling rod 15 and the lower preheat rolling rod 16 is 106° C.;
a temperature of the hot rolling of the upper heat rolling rod 17 and the lower heat rolling rod 18 is 111° C.;
a temperature of the hot rolling of the upper pre-calendering rod 19 and the lower pre-calendering rod 20 is 116° C.; and
a temperature of the hot rolling of the upper calendering rod 21 and the lower calendering rod 22 is 121° C.

The test results of this embodiment are shown in Table 1.

### Comparative Example 1

This comparative example provides a manufacturing method of a flash spinning polyethylene film material. Referring to FIG. 1, the specific steps are as follows:
(1) manufacturing of a flash evaporation spinning solution:
adding a spinning raw material and a spinning solvent into a high-pressure reaction kettle, and then heating up to 170° C.; introducing nitrogen gas at the end of the heating, and pressurizing to 12.8 MPa; and finally heating up to 215° C. to obtain the flash evaporation spinning solution;
the spinning raw material comprises polyethylene and tough particles; and
a mass fraction of the tough particles in the spinning raw material is 2%;
the tough particles are wrinkled graphene oxide microspheres; a specific surface area is 230 m²/g-250 m²/g, and a density is only 40 mg/cm³−50 mg/cm³; and the wrinkled graphene oxide microspheres utilize their unique wrinkled structure to play a role of buffering when a product is subjected to an external force, thereby enhancing its tensile strength.

The manufacturing method of the wrinkled graphene oxide microspheres is the same as that in Example 1, so it will not be repeated here.

The spinning solvent is dichloromethane, 1,1-dichloro-2,2,2-trifluoroethane, monochlorodichloromethane, and 1H-perfluorohexane, with a mass ratio of 6:2:1:1.

A mass fraction of the spinning raw material in the flash evaporation spinning solution is 11%.
(2) Manufacturing of the flash spinning polyethylene film material:
making the flash evaporation spinning solution manufactured in step (1) pass through a decompression chamber whose outlet being set a spinning component 1, performing flash spinning on the flash evaporation spinning solution through a spinning component to obtain flash spun fibers 3 which enter a laying system 4 through a spinning baffle 2 to obtain a raw fabric; pre-pressing the raw fabric preliminarily by an upper pre-pressing roller 10 and a lower pre-pressing roller 11, then making it enter a water tank 6, and controlling a sizing rate by a left extrusion roller 13 and a right extrusion roller 14 through a transmission rod 12 to obtain a pulp-containing raw fabric; making the pulp-containing raw fabric pass through an upper preheat rolling rod 15, a lower preheat rolling rod 16, an upper heat rolling rod 17, a lower heat rolling rod 18, an upper pre-calendering rod 19, a lower pre-calendering rod 20, an upper calendering rod 21, a lower calendering rod 22 in sequence, and finally pass through a winding machine 23 to obtain the flash spinning polyethylene film material; and
the water tank has a deionized water solution without a surfactant. When the deionized water solution is a pure deionized water, there may be local penetration points during the subsequent hot pressing process, mainly due to the uneven dispersion of deionized water in a felt.

The sizing rate is 11%, wherein the calculation of the sizing rate is [(wet weight-dry weight)/dry weight]*100%
a temperature of the heat rolling of the upper preheat rolling rod 15 and the lower preheat rolling rod 16 is 105° C.;
a temperature of the hot rolling of the upper heat rolling rod 17 and the lower heat rolling rod 18 is 110° C.;
a temperature of the hot rolling of the upper pre-calendering rod 19 and the lower pre-calendering rod 20 is 115° C.; and
a temperature of the hot rolling of the upper calendering rod 21 and the lower calendering rod 22 is 120° C.

The test results of this comparative example are shown in Table 1.

### Comparative Example 2

This comparative example provides a manufacturing method of a flash spinning polyethylene film material. Referring to FIG. 1, the specific steps are as follows:
(1) manufacturing of a flash evaporation spinning solution:
adding a spinning raw material and a spinning solvent into a high-pressure reaction kettle, and then heating up to 170° C.; introducing nitrogen gas at the end of the heating, and pressurizing to 12.8 MPa; and finally heating up to 215° C. to obtain the flash evaporation spinning solution;
the spinning raw material comprises polyethylene and tough particles; and
a mass fraction of the tough particles in the spinning raw material is 2%;
the tough particles are wrinkled graphene oxide microspheres; a specific surface area is 230 m²/g-250 m²/g, and a density is only 40 mg/cm³−50 mg/cm³; and the wrinkled graphene oxide microspheres utilize their unique wrinkled structure to play a role of buffering when a product is subjected to an external force, thereby enhancing its tensile strength.

The manufacturing method of the wrinkled graphene oxide microspheres is the same as that in Example 1, so it will not be repeated here.

The spinning solvent is dichloromethane, 1,1-dichloro-2,2,2-trifluoroethane, monochlorodichloromethane, and 1H-perfluorohexane, with a mass ratio of 6:2:1:1.

A mass fraction of the spinning raw material in the flash evaporation spinning solution is 11%.
(2) Manufacturing of the flash spinning polyethylene film material:
making the flash evaporation spinning solution manufactured in step (1) pass through a decompression chamber whose outlet being set a spinning component 1, performing flash spinning on the flash evaporation spinning solution through a spinning component to obtain flash spun fibers 3 which enter a laying system 4 through a spinning baffle 2 to obtain a raw fabric; pre-pressing the raw fabric preliminarily by an upper pre-pressing roller 10 and a lower pre-pressing roller 11, then making it enter a water tank 6, and controlling a sizing rate by a left extrusion roller 13 and a right extrusion roller 14 through a transmission rod 12 to obtain a pulp-containing raw fabric; making the pulp-containing raw fabric pass through an upper preheat rolling rod 15, a lower preheat rolling rod 16, an upper heat rolling rod 17, a lower heat rolling rod 18, an upper pre-calendering rod 19, a lower pre-calendering rod 20, an upper calendering rod 21, a lower calendering rod 22 in sequence, and finally pass through a winding machine 23 to obtain the flash spinning polyethylene film material; and
the water tank has a deionized water solution comprising a surfactant. When the deionized water solution is a pure deionized water, there may be local penetration points during the subsequent hot pressing process, mainly due to the uneven dispersion of deionized water in a felt. The present application overcomes its dispersion problem by adding the surfactant, thereby reducing the generation of local bright spots.

A mass fraction of the surfactant in the deionized water solution is 5%;
the surfactant is a diacetyl piperazine quaternary ammonium salt-Gemini surfactant;
the sizing rate is 11%, wherein the calculation of the sizing rate is [(wet weight-dry weight)/dry weight]*100%
a temperature of the heat rolling of the upper preheat rolling rod 15 and the lower preheat rolling rod 16 is 105° C.;
a temperature of the hot rolling of the upper heat rolling rod 17 and the lower heat rolling rod 18 is 110° C.;
a temperature of the hot rolling of the upper pre-calendering rod 19 and the lower pre-calendering rod 20 is 115° C.; and
a temperature of the hot rolling of the upper calendering rod 21 and the lower calendering rod 22 is 120° C.

The test results of this comparative example are shown in Table 1.

### Comparative Example 3

This comparative example provides a manufacturing method of a flash spinning polyethylene film material. Referring to FIG. 1, the specific steps are as follows:
(1) manufacturing of a flash evaporation spinning solution:
adding a spinning raw material and a spinning solvent into a high-pressure reaction kettle, and then heating up to 170° C.; introducing nitrogen gas at the end of the heating, and pressurizing to 12.8 MPa; and finally heating up to 215° C. to obtain the flash evaporation spinning solution;
the spinning raw material comprises polyethylene and tough particles; and
a mass fraction of the tough particles in the spinning raw material is 2%;
the tough particles are wrinkled graphene oxide microspheres; a specific surface area is 230 m²/g-250 m²/g, and a density is only 40 mg/cm³−50 mg/cm³; and the wrinkled graphene oxide microspheres utilize their unique wrinkled structure to play a role of buffering when a product is subjected to an external force, thereby enhancing its tensile strength.

The manufacturing method of the wrinkled graphene oxide microspheres is the same as that in Example 1, so it will not be repeated here.

The spinning solvent is dichloromethane, 1,1-dichloro-2,2,2-trifluoroethane, monochlorodichloromethane, and 1H-perfluorohexane, with a mass ratio of 6:2:1:1.

A mass fraction of the spinning raw material in the flash evaporation spinning solution is 11%.
(2) Manufacturing of the flash spinning polyethylene film material:
making the flash evaporation spinning solution manufactured in step (1) pass through a decompression chamber whose outlet being set a spinning component 1, performing flash spinning on the flash evaporation spinning solution through a spinning component to obtain flash spun fibers 3 which enter a laying system 4 through a spinning baffle 2 to obtain a raw fabric; pre-pressing the raw fabric preliminarily by an upper pre-pressing roller 10 and a lower pre-pressing roller 11, then making it enter a water tank 6, and controlling a sizing rate by a left extrusion roller 13 and a right extrusion roller 14 through a transmission rod 12 to obtain a pulp-containing raw fabric; making the pulp-containing raw fabric pass through an upper preheat rolling rod 15, a lower preheat rolling rod 16, an upper heat rolling rod 17, a lower heat rolling rod 18, an upper pre-calendering rod 19, a lower pre-calendering rod 20, an upper calendering rod 21, a lower calendering rod 22 in sequence, and finally pass through a winding machine 23 to obtain the flash spinning polyethylene film material; and
the water tank has a deionized water solution comprising a surfactant. When the deionized water solution is a pure deionized water, there may be local penetration points during the subsequent hot pressing process, mainly due to the uneven dispersion of deionized water in a felt. The present application overcomes its dispersion problem by adding the surfactant, thereby reducing the generation of local bright spots.

A mass fraction of the surfactant in the deionized water solution is 10%;
the surfactant is a diacetyl piperazine quaternary ammonium salt-Gemini surfactant;
the sizing rate is 11%, wherein the calculation of the sizing rate is [(wet weight-dry weight)/dry weight]*100%
a temperature of the heat rolling of the upper preheat rolling rod 15 and the lower preheat rolling rod 16 is 105° C.;
a temperature of the hot rolling of the upper heat rolling rod 17 and the lower heat rolling rod 18 is 110° C.;
a temperature of the hot rolling of the upper pre-calendering rod 19 and the lower pre-calendering rod 20 is 115° C.; and
a temperature of the hot rolling of the upper calendering rod 21 and the lower calendering rod 22 is 120° C.

The test results of this comparative example are shown in Table 1.

### Comparative Example 4

This comparative example provides a manufacturing method of a flash spinning polyethylene film material. Referring to FIG. 1, the specific steps are as follows:
(1) manufacturing of a flash evaporation spinning solution:
adding a spinning raw material and a spinning solvent into a high-pressure reaction kettle, and then heating up to 170° C.; introducing nitrogen gas at the end of the heating, and pressurizing to 12.8 MPa; and finally heating up to 215° C. to obtain the flash evaporation spinning solution;
the spinning raw material comprises polyethylene and tough particles; and
a mass fraction of the tough particles in the spinning raw material is 2%;
the tough particles are wrinkled graphene oxide microspheres; a specific surface area is 230 m²/g-250 m²/g, and a density is only 40 mg/cm³−50 mg/cm³; and the wrinkled graphene oxide microspheres utilize their unique wrinkled structure to play a role of buffering when a product is subjected to an external force, thereby enhancing its tensile strength.

The manufacturing method of the wrinkled graphene oxide microspheres is the same as that in Example 1, so it will not be repeated here.

The spinning solvent is dichloromethane, 1,1-dichloro-2,2,2-trifluoroethane, monochlorodichloromethane, and 1H-perfluorohexane, with a mass ratio of 6:2:1:1.

A mass fraction of the spinning raw material in the flash evaporation spinning solution is 11%.
(2) Manufacturing of the flash spinning polyethylene film material:
making the flash evaporation spinning solution manufactured in step (1) pass through a decompression chamber whose outlet being set a spinning component 1, performing flash spinning on the flash evaporation spinning solution through a spinning component to obtain flash spun fibers 3 which enter a laying system 4 through a spinning baffle 2 to obtain a raw fabric; pre-pressing the raw fabric preliminarily by an upper pre-pressing roller 10 and a lower pre-pressing roller 11, then making it enter a water tank 6, and controlling a sizing rate by a left extrusion roller 13 and a right extrusion roller 14 through a transmission rod 12 to obtain a pulp-containing raw fabric; making the pulp-containing raw fabric pass through an upper preheat rolling rod 15, a lower preheat rolling rod 16, an upper heat rolling rod 17, a lower heat rolling rod 18, an upper pre-calendering rod 19, a lower pre-calendering rod 20, an upper calendering rod 21, a lower calendering rod 22 in sequence, and finally pass through a winding machine 23 to obtain the flash spinning polyethylene film material; and
the water tank has a deionized water solution comprising a surfactant. When the deionized water solution is a pure deionized water, there may be local penetration points during the subsequent hot pressing process, mainly due to the uneven dispersion of deionized water in a felt. The present application overcomes its dispersion problem by adding the surfactant, thereby reducing the generation of local bright spots.

A mass fraction of the surfactant in the deionized water solution is 30%;
the surfactant is a diacetyl piperazine quaternary ammonium salt-Gemini surfactant;
the sizing rate is 11%, wherein the calculation of the sizing rate is [(wet weight-dry weight)/dry weight]*100%
a temperature of the heat rolling of the upper preheat rolling rod 15 and the lower preheat rolling rod 16 is 105° C.;
a temperature of the hot rolling of the upper heat rolling rod 17 and the lower heat rolling rod 18 is 110° C.;
a temperature of the hot rolling of the upper pre-calendering rod 19 and the lower pre-calendering rod 20 is 115° C.; and
a temperature of the hot rolling of the upper calendering rod 21 and the lower calendering rod 22 is 120° C.

The test results of this comparative example are shown in Table 1.

### Comparative Example 5

This comparative example provides a manufacturing method of a flash spinning polyethylene film material. Referring to FIG. 1, the specific steps are as follows:
(1) manufacturing of a flash evaporation spinning solution:
adding a spinning raw material and a spinning solvent into a high-pressure reaction kettle, and then heating up to 170° C.; introducing nitrogen gas at the end of the heating, and pressurizing to 12.8 MPa; and finally heating up to 215° C. to obtain the flash evaporation spinning solution;
the spinning raw material comprises polyethylene and tough particles; and
a mass fraction of the tough particles in the spinning raw material is 2%;
the tough particles are wrinkled graphene oxide microspheres; a specific surface area is 230 m²/g-250 m²/g, and a density is only 40 mg/cm³−50 mg/cm³; and the wrinkled graphene oxide microspheres utilize their unique wrinkled structure to play a role of buffering when a product is subjected to an external force, thereby enhancing its tensile strength.

The manufacturing method of the wrinkled graphene oxide microspheres is the same as that in Example 1, so it will not be repeated here.

The spinning solvent is dichloromethane, 1,1-dichloro-2,2,2-trifluoroethane, monochlorodichloromethane, and 1H-perfluorohexane, with a mass ratio of 6:2:1:1.

A mass fraction of the spinning raw material in the flash evaporation spinning solution is 11%.
(2) Manufacturing of the flash spinning polyethylene film material:
making the flash evaporation spinning solution manufactured in step (1) pass through a decompression chamber whose outlet being set a spinning component 1, performing flash spinning on the flash evaporation spinning solution through a spinning component to obtain flash spun fibers 3 which enter a laying system 4 through a spinning baffle 2 to obtain a raw fabric; pre-pressing the raw fabric preliminarily by an upper pre-pressing roller 10 and a lower pre-pressing roller 11, then making it enter a water tank 6, and controlling a sizing rate by a left extrusion roller 13 and a right extrusion roller 14 through a transmission rod 12 to obtain a pulp-containing raw fabric; making the pulp-containing raw fabric pass through an upper preheat rolling rod 15, a lower preheat rolling rod 16, an upper heat rolling rod 17, a lower heat rolling rod 18, an upper pre-calendering rod 19, a lower pre-calendering rod 20, an upper calendering rod 21, a lower calendering rod 22 in sequence, and finally pass through a winding machine 23 to obtain the flash spinning polyethylene film material; and
the water tank has a deionized water solution comprising a surfactant. When the deionized water solution is a pure deionized water, there may be local penetration points during the subsequent hot pressing process, mainly due to the uneven dispersion of deionized water in a felt. The present application overcomes its dispersion problem by adding the surfactant, thereby reducing the generation of local bright spots.

A mass fraction of the surfactant in the deionized water solution is 35%;
the surfactant is a diacetyl piperazine quaternary ammonium salt-Gemini surfactant;
the sizing rate is 11%, wherein the calculation of the sizing rate is [(wet weight-dry weight)/dry weight]*100%
a temperature of the heat rolling of the upper preheat rolling rod 15 and the lower preheat rolling rod 16 is 105° C.;
a temperature of the hot rolling of the upper heat rolling rod 17 and the lower heat rolling rod 18 is 110° C.;
a temperature of the hot rolling of the upper pre-calendering rod 19 and the lower pre-calendering rod 20 is 115° C.; and
a temperature of the hot rolling of the upper calendering rod 21 and the lower calendering rod 22 is 120° C.

The test results of this comparative example are shown in Table 1.

### Comparative Example 6

This comparative example provides a manufacturing method of a flash spinning polyethylene film material. Referring to FIG. 1, the specific steps are as follows:
(1) manufacturing of a flash evaporation spinning solution:
adding a spinning raw material and a spinning solvent into a high-pressure reaction kettle, and then heating up to 170° C.; introducing nitrogen gas at the end of the heating, and pressurizing to 12.8 MPa; and finally heating up to 215° C. to obtain the flash evaporation spinning solution;
the spinning raw material is polyethylene; and

The spinning solvent is dichloromethane, 1,1-dichloro-2,2,2-trifluoroethane, monochlorodichloromethane, and 1H-perfluorohexane, with a mass ratio of 6:2:1:1.

A mass fraction of the spinning raw material in the flash evaporation spinning solution is 11%.
(2) Manufacturing of the flash spinning polyethylene film material:
making the flash evaporation spinning solution manufactured in step (1) pass through a decompression chamber whose outlet being set a spinning component 1, performing flash spinning on the flash evaporation spinning solution through a spinning component to obtain flash spun fibers 3 which enter a laying system 4 through a spinning baffle 2 to obtain a raw fabric; pre-pressing the raw fabric preliminarily by an upper pre-pressing roller 10 and a lower pre-pressing roller 11, then making it enter a water tank 6, and controlling a sizing rate by a left extrusion roller 13 and a right extrusion roller 14 through a transmission rod 12 to obtain a pulp-containing raw fabric; making the pulp-containing raw fabric pass through an upper preheat rolling rod 15, a lower preheat rolling rod 16, an upper heat rolling rod 17, a lower heat rolling rod 18, an upper pre-calendering rod 19, a lower pre-calendering rod 20, an upper calendering rod 21, a lower calendering rod 22 in sequence, and finally pass through a winding machine 23 to obtain the flash spinning polyethylene film material; and
the water tank has a deionized water solution comprising a surfactant. When the deionized water solution is a pure deionized water, there may be local penetration points during the subsequent hot pressing process, mainly due to the uneven dispersion of deionized water in a felt. The present application overcomes its dispersion problem by adding the surfactant, thereby reducing the generation of local bright spots.

A mass fraction of the surfactant in the deionized water solution is 20%;
the surfactant is a diacetyl piperazine quaternary ammonium salt-Gemini surfactant;
the sizing rate is 11%, wherein the calculation of the sizing rate is [(wet weight-dry weight)/dry weight]*100%
a temperature of the heat rolling of the upper preheat rolling rod 15 and the lower preheat rolling rod 16 is 105° C.;
a temperature of the hot rolling of the upper heat rolling rod 17 and the lower heat rolling rod 18 is 110° C.;
a temperature of the hot rolling of the upper pre-calendering rod 19 and the lower pre-calendering rod 20 is 115° C.; and
a temperature of the hot rolling of the upper calendering rod 21 and the lower calendering rod 22 is 120° C.

The test results of this comparative example are shown in Table 1.

### Comparative Example 7

This comparative example provides a manufacturing method of a flash spinning polyethylene film material. Referring to FIG. 1, the specific steps are as follows:
(1) manufacturing of a flash evaporation spinning solution:
adding a spinning raw material and a spinning solvent into a high-pressure reaction kettle, and then heating up to 170° C.; introducing nitrogen gas at the end of the heating, and pressurizing to 12.8 MPa; and finally heating up to 215° C. to obtain the flash evaporation spinning solution;
the spinning raw material comprises polyethylene and tough particles; and
a mass fraction of the tough particles in the spinning raw material is 0.5%;
the tough particles are wrinkled graphene oxide microspheres; a specific surface area is 230 m²/g-250 m²/g, and a density is only 40 mg/cm³−50 mg/cm³; and the wrinkled graphene oxide microspheres utilize their unique wrinkled structure to play a role of buffering when a product is subjected to an external force, thereby enhancing its tensile strength.

The manufacturing method of the wrinkled graphene oxide microspheres is the same as that in Example 1, so it will not be repeated here.

The spinning solvent is dichloromethane, 1,1-dichloro-2,2,2-trifluoroethane, monochlorodichloromethane, and 1H-perfluorohexane, with a mass ratio of 6:2:1:1.

A mass fraction of the spinning raw material in the flash evaporation spinning solution is 11%.
(2) Manufacturing of the flash spinning polyethylene film material:
making the flash evaporation spinning solution manufactured in step (1) pass through a decompression chamber whose outlet being set a spinning component 1, performing flash spinning on the flash evaporation spinning solution through a spinning component to obtain flash spun fibers 3 which enter a laying system 4 through a spinning baffle 2 to obtain a raw fabric; pre-pressing the raw fabric preliminarily by an upper pre-pressing roller 10 and a lower pre-pressing roller 11, then making it enter a water tank 6, and controlling a sizing rate by a left extrusion roller 13 and a right extrusion roller 14 through a transmission rod 12 to obtain a pulp-containing raw fabric; making the pulp-containing raw fabric pass through an upper preheat rolling rod 15, a lower preheat rolling rod 16, an upper heat rolling rod 17, a lower heat rolling rod 18, an upper pre-calendering rod 19, a lower pre-calendering rod 20, an upper calendering rod 21, a lower calendering rod 22 in sequence, and finally pass through a winding machine 23 to obtain the flash spinning polyethylene film material; and
the water tank has a deionized water solution comprising a surfactant. When the deionized water solution is a pure deionized water, there may be local penetration points during the subsequent hot pressing process, mainly due to the uneven dispersion of deionized water in a felt. The present application overcomes its dispersion problem by adding the surfactant, thereby reducing the generation of local bright spots.

A mass fraction of the surfactant in the deionized water solution is 20%;
the surfactant is a diacetyl piperazine quaternary ammonium salt-Gemini surfactant;
the sizing rate is 11%, wherein the calculation of the sizing rate is [(wet weight-dry weight)/dry weight]*100%
a temperature of the heat rolling of the upper preheat rolling rod 15 and the lower preheat rolling rod 16 is 105° C.;
a temperature of the hot rolling of the upper heat rolling rod 17 and the lower heat rolling rod 18 is 110° C.;
a temperature of the hot rolling of the upper pre-calendering rod 19 and the lower pre-calendering rod 20 is 115° C.; and
a temperature of the hot rolling of the upper calendering rod 21 and the lower calendering rod 22 is 120° C.

The test results of this comparative example are shown in Table 1.

### Comparative Example 8

This comparative example provides a manufacturing method of a flash spinning polyethylene film material. Referring to FIG. 1, the specific steps are as follows:
(1) manufacturing of a flash evaporation spinning solution:
adding a spinning raw material and a spinning solvent into a high-pressure reaction kettle, and then heating up to 170° C.; introducing nitrogen gas at the end of the heating, and pressurizing to 12.8 MPa; and finally heating up to 215° C. to obtain the flash evaporation spinning solution;
the spinning raw material comprises polyethylene and tough particles; and
a mass fraction of the tough particles in the spinning raw material is 1%;
the tough particles are wrinkled graphene oxide microspheres; a specific surface area is 230 m²/g-250 m²/g, and a density is only 40 mg/cm³−50 mg/cm³; and the wrinkled graphene oxide microspheres utilize their unique wrinkled structure to play a role of buffering when a product is subjected to an external force, thereby enhancing its tensile strength.

The manufacturing method of the wrinkled graphene oxide microspheres is the same as that in Example 1, so it will not be repeated here.

The spinning solvent is dichloromethane, 1,1-dichloro-2,2,2-trifluoroethane, monochlorodichloromethane, and 1H-perfluorohexane, with a mass ratio of 6:2:1:1.

A mass fraction of the spinning raw material in the flash evaporation spinning solution is 11%.
(2) Manufacturing of the flash spinning polyethylene film material:
making the flash evaporation spinning solution manufactured in step (1) pass through a decompression chamber whose outlet being set a spinning component 1, performing flash spinning on the flash evaporation spinning solution through a spinning component to obtain flash spun fibers 3 which enter a laying system 4 through a spinning baffle 2 to obtain a raw fabric; pre-pressing the raw fabric preliminarily by an upper pre-pressing roller 10 and a lower pre-pressing roller 11, then making it enter a water tank 6, and controlling a sizing rate by a left extrusion roller 13 and a right extrusion roller 14 through a transmission rod 12 to obtain a pulp-containing raw fabric; making the pulp-containing raw fabric pass through an upper preheat rolling rod 15, a lower preheat rolling rod 16, an upper heat rolling rod 17, a lower heat rolling rod 18, an upper pre-calendering rod 19, a lower pre-calendering rod 20, an upper calendering rod 21, a lower calendering rod 22 in sequence, and finally pass through a winding machine 23 to obtain the flash spinning polyethylene film material; and
the water tank has a deionized water solution comprising a surfactant. When the deionized water solution is a pure deionized water, there may be local penetration points during the subsequent hot pressing process, mainly due to the uneven dispersion of deionized water in a felt. The present application overcomes its dispersion problem by adding the surfactant, thereby reducing the generation of local bright spots.

A mass fraction of the surfactant in the deionized water solution is 20%;
the surfactant is a diacetyl piperazine quaternary ammonium salt-Gemini surfactant;
the sizing rate is 11%, wherein the calculation of the sizing rate is [(wet weight-dry weight)/dry weight]*100%
a temperature of the heat rolling of the upper preheat rolling rod 15 and the lower preheat rolling rod 16 is 105° C.;
a temperature of the hot rolling of the upper heat rolling rod 17 and the lower heat rolling rod 18 is 110° C.;
a temperature of the hot rolling of the upper pre-calendering rod 19 and the lower pre-calendering rod 20 is 115° C.; and
a temperature of the hot rolling of the upper calendering rod 21 and the lower calendering rod 22 is 120° C.

The test results of this comparative example are shown in Table 1.

### Comparative Example 9

This comparative example provides a manufacturing method of a flash spinning polyethylene film material. Referring to FIG. 1, the specific steps are as follows:
(1) manufacturing of a flash evaporation spinning solution:
adding a spinning raw material and a spinning solvent into a high-pressure reaction kettle, and then heating up to 170° C.; introducing nitrogen gas at the end of the heating, and pressurizing to 12.8 MPa; and finally heating up to 215° C. to obtain the flash evaporation spinning solution;
the spinning raw material comprises polyethylene and tough particles; and
a mass fraction of the tough particles in the spinning raw material is 3%;
the tough particles are wrinkled graphene oxide microspheres; a specific surface area is 230 m²/g-250 m²/g, and a density is only 40 mg/cm³−50 mg/cm³; and the wrinkled graphene oxide microspheres utilize their unique wrinkled structure to play a role of buffering when a product is subjected to an external force, thereby enhancing its tensile strength.

The manufacturing method of the wrinkled graphene oxide microspheres is the same as that in Example 1, so it will not be repeated here.

The spinning solvent is dichloromethane, 1,1-dichloro-2,2,2-trifluoroethane, monochlorodichloromethane, and 1H-perfluorohexane, with a mass ratio of 6:2:1:1.

A mass fraction of the spinning raw material in the flash evaporation spinning solution is 11%.
(2) Manufacturing of the flash spinning polyethylene film material:
making the flash evaporation spinning solution manufactured in step (1) pass through a decompression chamber whose outlet being set a spinning component 1, performing flash spinning on the flash evaporation spinning solution through a spinning component to obtain flash spun fibers 3 which enter a laying system 4 through a spinning baffle 2 to obtain a raw fabric; pre-pressing the raw fabric preliminarily by an upper pre-pressing roller 10 and a lower pre-pressing roller 11, then making it enter a water tank 6, and controlling a sizing rate by a left extrusion roller 13 and a right extrusion roller 14 through a transmission rod 12 to obtain a pulp-containing raw fabric; making the pulp-containing raw fabric pass through an upper preheat rolling rod 15, a lower preheat rolling rod 16, an upper heat rolling rod 17, a lower heat rolling rod 18, an upper pre-calendering rod 19, a lower pre-calendering rod 20, an upper calendering rod 21, a lower calendering rod 22 in sequence, and finally pass through a winding machine 23 to obtain the flash spinning polyethylene film material; and
the water tank has a deionized water solution comprising a surfactant. When the deionized water solution is a pure deionized water, there may be local penetration points during the subsequent hot pressing process, mainly due to the uneven dispersion of deionized water in a felt. The present application overcomes its dispersion problem by adding the surfactant, thereby reducing the generation of local bright spots.

A mass fraction of the surfactant in the deionized water solution is 20%;
the surfactant is a diacetyl piperazine quaternary ammonium salt-Gemini surfactant;
the sizing rate is 11%, wherein the calculation of the sizing rate is [(wet weight-dry weight)/dry weight]*100%
a temperature of the heat rolling of the upper preheat rolling rod 15 and the lower preheat rolling rod 16 is 105° C.;
a temperature of the hot rolling of the upper heat rolling rod 17 and the lower heat rolling rod 18 is 110° C.;
a temperature of the hot rolling of the upper pre-calendering rod 19 and the lower pre-calendering rod 20 is 115° C.; and
a temperature of the hot rolling of the upper calendering rod 21 and the lower calendering rod 22 is 120° C.

The test results of this comparative example are shown in Table 1.

### Comparative Example 10

This comparative example provides a manufacturing method of a flash spinning polyethylene film material. Referring to FIG. 1, the specific steps are as follows:
(1) manufacturing of a flash evaporation spinning solution:
adding a spinning raw material and a spinning solvent into a high-pressure reaction kettle, and then heating up to 170° C.; introducing nitrogen gas at the end of the heating, and pressurizing to 12.8 MPa; and finally heating up to 215° C. to obtain the flash evaporation spinning solution;
the spinning raw material comprises polyethylene and tough particles; and
a mass fraction of the tough particles in the spinning raw material is 3.5%;
the tough particles are wrinkled graphene oxide microspheres; a specific surface area is 230 m²/g-250 m²/g, and a density is only 40 mg/cm³−50 mg/cm³; and the wrinkled graphene oxide microspheres utilize their unique wrinkled structure to play a role of buffering when a product is subjected to an external force, thereby enhancing its tensile strength.

The manufacturing method of the wrinkled graphene oxide microspheres is the same as that in Example 1, so it will not be repeated here.

The spinning solvent is dichloromethane, 1,1-dichloro-2,2,2-trifluoroethane, monochlorodichloromethane, and 1H-perfluorohexane, with a mass ratio of 6:2:1:1.

A mass fraction of the spinning raw material in the flash evaporation spinning solution is 11%.
(2) Manufacturing of the flash spinning polyethylene film material:
making the flash evaporation spinning solution manufactured in step (1) pass through a decompression chamber whose outlet being set a spinning component 1, performing flash spinning on the flash evaporation spinning solution through a spinning component to obtain flash spun fibers 3 which enter a laying system 4 through a spinning baffle 2 to obtain a raw fabric; pre-pressing the raw fabric preliminarily by an upper pre-pressing roller 10 and a lower pre-pressing roller 11, then making it enter a water tank 6, and controlling a sizing rate by a left extrusion roller 13 and a right extrusion roller 14 through a transmission rod 12 to obtain a pulp-containing raw fabric; making the pulp-containing raw fabric pass through an upper preheat rolling rod 15, a lower preheat rolling rod 16, an upper heat rolling rod 17, a lower heat rolling rod 18, an upper pre-calendering rod 19, a lower pre-calendering rod 20, an upper calendering rod 21, a lower calendering rod 22 in sequence, and finally pass through a winding machine 23 to obtain the flash spinning polyethylene film material; and
the water tank has a deionized water solution comprising a surfactant. When the deionized water solution is a pure deionized water, there may be local penetration points during the subsequent hot pressing process, mainly due to the uneven dispersion of deionized water in a felt. The present application overcomes its dispersion problem by adding the surfactant, thereby reducing the generation of local bright spots.

A mass fraction of the surfactant in the deionized water solution is 20%;
the surfactant is a diacetyl piperazine quaternary ammonium salt-Gemini surfactant;
the sizing rate is 11%, wherein the calculation of the sizing rate is [(wet weight-dry weight)/dry weight]*100%
a temperature of the heat rolling of the upper preheat rolling rod 15 and the lower preheat rolling rod 16 is 105° C.;
a temperature of the hot rolling of the upper heat rolling rod 17 and the lower heat rolling rod 18 is 110° C.;
a temperature of the hot rolling of the upper pre-calendering rod 19 and the lower pre-calendering rod 20 is 115° C.; and
a temperature of the hot rolling of the upper calendering rod 21 and the lower calendering rod 22 is 120° C.

The test results of this comparative example are shown in Table 1.

TABLE 1
Test data table

| | | | | Light |
|---|---|---|---|---|
| | Z₀ | Z₁₀ | •Z | transmittance |
| | (N · m)/g | (N · m)/g | % | % |
| Example 1 | 28.6 | 22.2 | 0.224 | 11.1 |
| Example 2 | 31.6 | 25.7 | 0.187 | 10.3 |
| Example 3 | 33.5 | 28.2 | 0.158 | 9.5 |
| Comparative | 14.6 | 9.1 | 0.377 | 8.1 |
| Example 1 | | | | |
| Comparative | 17.7 | 12.7 | 0.282 | 8.4 |
| Example 2 | | | | |
| Comparative | 19.1 | 14.2 | 0.257 | 8.8 |
| Example 3 | | | | |
| Comparative | 33.9 | 28.6 | 0.156 | 15.5 |
| Example 4 | | | | |
| Comparative | 34.1 | 28.8 | 0.155 | 16.5 |
| Example 5 | | | | |
| Comparative | 16.8 | 11.3 | 0.327 | 13.5 |
| Example 6 | | | | |
| Comparative | 17.6 | 12.1 | 0.313 | 12.1 |
| Example 7 | | | | |
| Comparative | 18.4 | 13.2 | 0.283 | 11.4 |
| Example 8 | | | | |
| Comparative | 33.9 | 28.6 | 0.156 | 8.6 |
| Example 9 | | | | |
| Comparative | 34.1 | 28.8 | 0.155 | 8.2 |
| Example 10 | | | | |

Result analysis: comparing the above data, it can be seen that increasing the amount of the toughness particles can improve the initial toughness of the product, reduce the toughness change value of the product, but at the same time, it can also lead to a decrease in the product transmittance. Increasing the dosage of the surfactant can increase the light transmittance and the initial toughness, reduce the toughness change value of the product, and reduce the generation of the local bright spots. Therefore, by adjusting the dosage of the tough particles and the surfactant, a product with a suitable toughness and a light transmittance property can be obtained, achieving the expected purpose of the present disclosure.

The specific embodiments described herein are merely illustrative of the spirit of the present disclosure. It is apparent to those skilled in the art that various modifications, amendments and alternatives can be made to the described embodiments without departing from the spirit of the present disclosure or scope defined by the appended claims.

Although this article extensively uses terms such as a spinning component 1, a baffle 2, flash spun fibers 3, a laying system 4, a guide roller 5, a water tank 6, an upper pre-pressing roller 10, a lower pre-pressing roller 11, a transmission rod 12, a left extrusion roller 13, a right extrusion roller 14, an upper preheat rolling rod 15, a lower preheat rolling rod 16, an upper heat rolling rod 17, a lower heat rolling rod 18, an upper pre-calendering rod 19, a lower pre-calendering rod 20, an upper calendering rod 21, a lower calendering rod 22, and a winding machine 23, etc., the possibility of using other terms is not ruled out. These terms are merely used for describing and explaining the essence of the present disclosure more conveniently; and interpreting them as any additional limitations deviates from the spirit of the present disclosure.

1. A flash spinning polyethylene film material with better toughness, wherein a raw material thereof comprises polyethylene,
a grammage G of the flash spinning polyethylene film material is greater than 50 g/m²;
an initial toughness Z₀ of the flash spinning polyethylene film material is 20 (N·m)/g-35 (N·m)/g;
$${Z}_{0} = [ {R}_{M} \times {E}_{M} + {R}_{T} \times {E}_{T} ] / G ;$$
wherein,
R_{M} is a tensile strength in as machine direction (MD);
R_{T} is a tensile strength in a traverse direction (TD);
E_{M} is a tensile elongation in the (MD);
E_{T} is a tensile elongation in the TD;
the flash spinning polyethylene film material is exposed to a dry and hot atmosphere of 90° C. for 6 hours, and then cooled at 25° C. and a relative humidity of 65% for 24 hours; then a light transmittance thereof is measured to be 8%-13%; and
the light transmittance is tested according to GBT2410-2008, and the light transmittance is a ratio of a luminous flux passing through a sample to a luminous flux incident on the sample, expressed as a percentage.

2. The flash spinning polyethylene film material with better toughness of claim 1, wherein the initial toughness Z₀ of the flash spinning polyethylene film material is 20 (N·m)/g-25 (N·m)/g.

3. The flash spinning polyethylene film material with better toughness of claim 1, wherein the initial toughness Z₀ of the flash spinning polyethylene film material is 25 (N·m)/g-30 (N·m)/g.

4. The flash spinning polyethylene film material with better toughness of claim 1, wherein the initial toughness Z₀ of the flash spinning polyethylene film material is 30 (N·m)/g-35 (N·m)/g.

5. The flash spinning polyethylene film material with better toughness of claim 1, wherein the light transmittance of the flash spinning polyethylene film material is 8%-9%.

6. The flash spinning polyethylene film material with better toughness of claim 1, wherein the light transmittance of the flash spinning polyethylene film material is 9%-10%.

7. The flash spinning polyethylene film material with better toughness of claim 1, wherein the light transmittance of the flash spinning polyethylene film material is 10%-11%.

8. The flash spinning polyethylene film material with better toughness of claim 1, wherein a toughness change value (·Z) of the flash spinning polyethylene film material is 15%-25%;
wherein: •Z=[Z₀−Z₁₀]/Z₀*100%
Z₀ is the initial toughness, and the initial toughness is Z₀=[R_{M}×E_{M}+R_{T}×E_{T}]/G of the sample;
Z₁₀ is a final toughness Z₁₀-after high temperature treatment, and Z₁₀=[R_{M10}×E_{M10}+R_{T10}×E_{T10}]/G;
a process flow of the high temperature treatment is as follows:
(1) placing the sample at 25° C. and a relative humidity of 65% for 24 hours, and then measuring the tensile strength (R_{M}) in the MD, the tensile strength (R_{T}) in the TD, the tensile elongation (E_{M}) in the MD, and the tensile elongation (E_{T}) in the TD of the sample separately; then calculating Z₀ according to a formula;
(2) then exposing the sample to the dry and hot atmosphere of 90° C. for 6 hours, and then cooling at 25° C. and a relative humidity of 65% for 24 hours; and
(3) finally repeating the step (2), and after treatment for 9 times, measuring the tensile strength (R_{M10}) in the MD, the tensile strength (R_{T10}) in the TD, the tensile elongation (E_{M10}) in the MD, and the tensile elongation (E_{T10}) in the TD of the sample separately; then calculating Z₁₀ according to the formula.

9. The flash spinning polyethylene film material with better toughness of claim 8, wherein the toughness change value (·Z) of the flash spinning polyethylene film material is 15%-20%.

10. The flash spinning polyethylene film material with better toughness of claim 8, wherein the toughness change value (·Z) of the flash spinning polyethylene film material is 20%-25%.

11. A manufacturing method of a flash spinning polyethylene film material with better toughness, wherein specific steps are as follows:
(1) manufacturing of a flash evaporation spinning solution by:
adding a spinning raw material and a spinning solvent into a high-pressure reaction kettle, and then heating up to 160° C.-180° C.; introducing nitrogen gas at the an end of the heating, and pressurizing to 12.5 MPa-13 MPa; and finally heating up to 200° C.-230° C. to obtain the flash evaporation spinning solution;
the spinning raw material comprises polyethylene and tough particles; and
the tough particles are wrinkled graphene oxide microspheres;
(2) manufacturing of the flash spinning polyethylene film material by:
performing flash spinning on the flash evaporation spinning solution manufactured in the step (1) through a spinning component (1) disposed in a decompression chamber to obtain a flash spinning fiber (3), laying and pre-pressing the flash spinning fiber (3) and letting the same enter a water tank (6), and then performing extruding, hot rolling, calendering and winding to obtain the flash spinning polyethylene film material;
the water tank (6) has a deionized water solution comprising a surfactant.
